(19) United States
(12) Patent Application Publication
(10) Pub. No.: US 2025/0034011 A1
(43) Pub. Date: Jan. 30, 2025

(54) DEVICES, SYSTEMS, AND METHODS FOR WATER TREATMENT

(71) Applicant: INNOVATIVE WATER CARE, LLC, Alpharetta, GA (US)

(72) Inventors: Stephane Gautier, Atlanta, GA (US); Michael Paloian, Lloyd Harbor, NY (US)

(73) Assignee: INNOVATIVE WATER CARE, LLC, Alpharetta, GA (US)

(21) Appl. No.: 18/782,043

(22) Filed: Jul. 24, 2024

Related U.S. Application Data
(60) Provisional application No. 63/515,358, filed on Jul. 25, 2023.

(51) Int. Cl. C02F 1/68; C02F 1/66

(52) U.S. Cl. CPC C02F 1/685; C02F 1/66; C02F 2209/003; C02F 2209/006; C02F 2209/008; C02F 2209/06

(57) ABSTRACT

Devices, systems, and methods for water treatment are provided. The devices include a sensor module configured to receive a stream of water from a body of water, the sensor module including sensor assemblies configured to monitor characteristics of the stream of water, and a control module in operable communication with the sensor module and a chemical feed system configured to supply one or more chemicals to the body of water. The control module is configured to, by one or more processors: receive sensor data from the sensor module indicative of the characteristics of the stream of water, analyze the characteristics of the stream of water relative to programmed criteria, and adjust a supply rate of the chemical feed system to supply the one or more chemicals to the body of water based on the analysis of the characteristics of the stream of water.

### CROSS REFERENCE TO RELATED APPLICATION

The present application claims the benefit of prior filed U.S. Provisional Patent Application No. 63/515,358, filed Jul. 25, 2023, which is hereby incorporated by reference herein in its entirety.

### TECHNICAL FIELD OF THE INVENTION

The present invention generally relates to water treatment, and more particularly relates to devices, systems, and methods for monitoring water chemistry and controlling chemical feed systems for treating the water.

### BACKGROUND OF THE INVENTION

Water is used in many commercial, industrial, and recreational applications. Depending on the specific end use, water may require specific treatments. The end use may include, but is not limited to, drinking, industrial water supply, irrigation, river flow maintenance, water recreation, or many other uses, including the safe return of used water to the environment. Water treatment generally improves the quality of the water by removing contaminants and undesirable components or reducing their concentration so that the water becomes fit for its desired end use. When left untreated, water may cause corrosion or mechanical failure of equipment to occur, resulting in costly repairs. Furthermore, in certain applications, if left untreated, water may provide for growth of bacteria, algae, and other undesirable organisms, such that persons exposed to an untreated water supply, either by way of ingestion or direct physical contact, may become ill and face serious medical issues, and possibly death.

Common water treatment practices generally rely on the introduction of treatment chemicals to control such organisms on a periodic or continuous basis. For example, some water treatment systems use chemical feed systems that are intended to supply a chemical solution comprising one or more treatment chemicals to the water in a controlled manner. A common treatment chemical includes chlorine which is generally expressed as a concentration of free available chlorine (FAC).

Typically, components of water treatment systems are individually operated manually or automatically without communication therebetween. As such, conventional water treatment systems generally require considerable supervision and intervention (i.e., monitoring equipment and periodic water testing) to ensure the components of the water treatment system are functioning as intended, which can be arduous and time consuming.

Hence, there is a need for devices and methods for water treatment that can promote case of monitoring and controlling water treatment systems and reduce the supervision and intervention necessary to ensure desirable water chemistry. Furthermore, other desirable features and characteristics of the present invention will become apparent from the subsequent detailed description and the appended claims, taken in conjunction with the accompanying drawings and the foregoing technical field and background.

### SUMMARY OF THE INVENTION

This summary is provided to describe select concepts in a simplified form that are further described in the Detailed Description. This summary is not intended to identify key or essential features of the claimed subject matter, nor is it intended to be used as an aid in determining the scope of the claimed subject matter.

In various embodiments, a water treatment device is provided that includes a sensor module configured to receive a stream of water from a body of water, the sensor module including sensor assemblies configured to monitor characteristics of the stream of water, and a control module in operable communication with the sensor module and a chemical feed system configured to supply one or more chemicals to the body of water. The control module is configured to, by one or more processors: receive sensor data from the sensor module indicative of the characteristics of the stream of water, analyze the characteristics of the stream of water relative to programmed criteria, and adjust a supply rate of the chemical feed system to supply the one or more chemicals to the body of water based on the analysis of the characteristics of the stream of water.

In various embodiments, a system is provided that includes a chemical feed system configured to supply one or more chemicals to a body of water, and a water treatment control device that includes a sensor module configured to receive a stream of water from the body of water, the sensor module including sensor assemblies configured to monitor characteristics of the stream of water, and a control module in operable communication with the sensor module and the chemical feed system. The control module is configured to, by one or more processors: receive sensor data from the sensor module indicative of the characteristics of the stream of water, analyze the characteristics of the stream of water relative to programmed criteria, and adjust a supply rate of the chemical feed system to supply the one or more chemicals to the body of water based on the analysis of the characteristics of the stream of water.

In various embodiments, a method is provided that includes directing a stream of water from a body of water to a sensor module of a water treatment control device, monitoring, with sensor assemblies of the sensor module, characteristics of the stream of water, analyzing, with one or more processors of a control module of the water treatment control device, the characteristics of the stream of water relative to programmed criteria, and adjusting, with the one or more processors of the control module, a supply rate of a chemical feed system to selectively supply one or more chemicals to the body of water based on the analysis of the characteristics of the stream of water.

Furthermore, other desirable features and characteristics of the device and method will become apparent from the subsequent detailed description and the appended claims, taken in conjunction with the accompanying drawings and the preceding background.

### BRIEF DESCRIPTION OF DRAWINGS

The present disclosure will hereinafter be described in conjunction with the following drawing figures, wherein like numerals denote like elements, and wherein:

FIG. 1 schematically represents a water treatment system in accordance with various nonlimiting embodiments;

FIG. 2 is a dataflow diagram illustrating operation of a water treatment control device of FIG. 1 in accordance with various nonlimiting embodiments;

FIG. 3 includes front top, rear top, and front bottom perspective views of a water treatment control device in accordance with various nonlimiting embodiments;

FIG. 4 includes rear, side, front, top, and bottom views of the water treatment control device of FIG. 3;

FIGS. 5 and 6 include front views of the water treatment control device of FIGS. 3 and 4 with a cover thereof removed. FIG. 6 omits certain components presented in FIG. 5 for clarity;

FIG. 7 is an exploded view of various components of the water treatment control device of FIGS. 3-6;

FIGS. 8 and 9 include exploded views of a control module of the water treatment control device of FIGS. 3-7;

FIGS. 10 and 11 include exploded views of a sensor module of the water treatment control device of FIGS. 3-7;

FIG. 12 is an exploded view of a sensor assembly of the water treatment control device of FIGS. 3-7; and

FIG. 13 is a flowchart illustrating an exemplary method for treating water in accordance with various nonlimiting embodiments.

Further areas of applicability will become apparent from the description provided herein. The description and specific examples in this summary are intended for purposes of illustration only and are not intended to limit the scope of the present disclosure.

### DETAILED DESCRIPTION

The following detailed description is merely exemplary in nature and is not intended to limit the invention or the application and uses of the invention. As used herein, the word “exemplary” means “serving as an example, instance, or illustration.” Thus, any embodiment described herein as “exemplary” is not necessarily to be construed as preferred or advantageous over other embodiments. All of the embodiments described herein are exemplary embodiments provided to enable persons skilled in the art to make or use the invention and not to limit the scope of the invention which is defined by the claims. Furthermore, there is no intention to be bound by any expressed or implied theory presented in the preceding technical field, background, brief summary, or the following detailed description.

For the sake of brevity, conventional techniques related to signal processing, data transmission, signaling, control, and other functional aspects of the systems (and the individual operating components of the systems) may not be described in detail herein. Furthermore, the connecting lines shown in the various figures contained herein are intended to represent example functional relationships and/or physical couplings between the various elements. It should be noted that many alternative or additional functional relationships or physical connections may be present in an embodiment of the present disclosure.

By way of overview, the present invention is directed to devices and related systems and methods for water treatment, as the devices and systems may be used to monitor water characteristics and supply chemical solutions including mixtures of chemical materials with an aqueous fluid (e.g., water) to bodies of water undergoing treatment. The devices and systems of the present invention may be particularly useful for commercial or residential swimming pool chemical treatment, municipal drinking water chemical treatment, agricultural water chemical treatment, and industrial water chemical treatment.

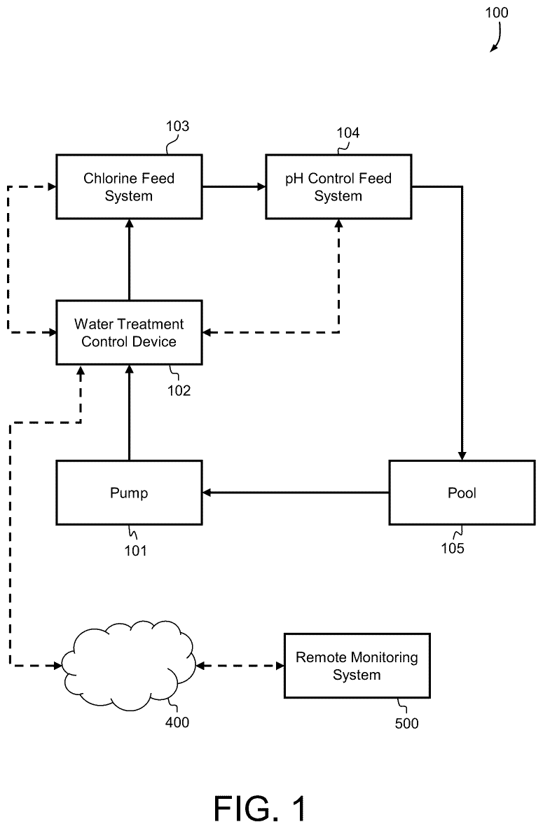

FIG. 1 shows certain aspects of an exemplary embodiment of a water treatment system 100 consistent with the present disclosure. For convenience, the system 100 is discussed herein in relation to use in a commercial or residential swimming pool 105. However, the system 100 and related systems are not limited to any particular application. Typically, pool water is drawn from a pool with a pump, forced through a filter (e.g., cartridge filters, sand filters, diatomaceous earth filters, etc.) and, optionally, through various other pool system components (e.g., a water heating device, chemical feed systems, salination systems, etc.), and then returned to the pool via a return line. For clarity, FIG. 1 is limited to certain components of the system 100 that are particularly relevant to the discussion herein. However, it should be understood that the system 100 may include various other systems and components in addition to or as alternatives for those presented in FIG. 1. Such other systems may include, for example, various piping, fixtures, and valves, and/or various other components related to the transport, treatment, and/or conditioning of the pool water. In addition, the system 100 is discussed herein in relation to chlorination and pH control of the pool water of the pool 105. However, the system 100 is not limited is any particular chemical treatment or chemical.

Referring to FIG. 1, the system 100 includes a water treatment control device 102 configured to monitor characteristics of the pool water and communicate with and/or control chemical feed systems to supply chemicals and/or chemical solutions to the pool water. In this example, the chemical feed systems include a chlorine feed system 103 and a pH control feed system 104. In general, pool water may be pumped from the pool 105 by a pump 101, directed through the device 102, directed to the chlorine feed system 103 and the pH control feed system 104 wherein the pool water is treated, and then returned to the pool 105.

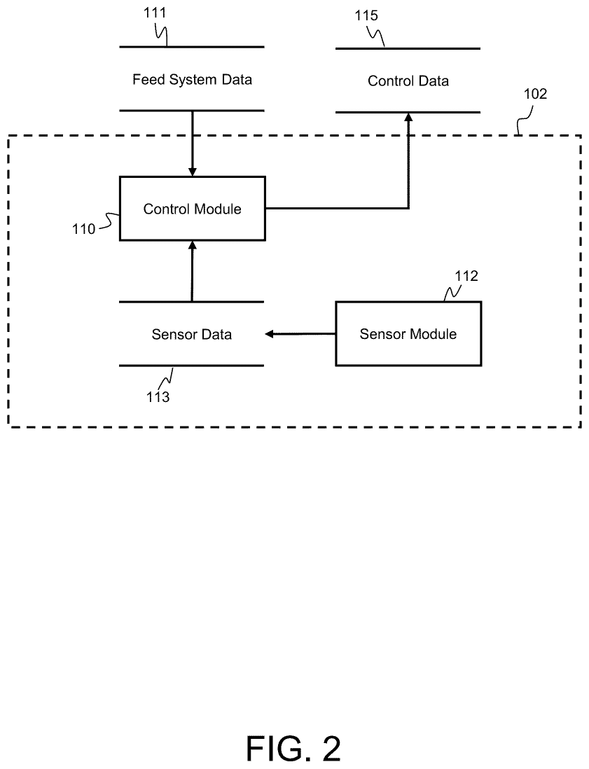

Referring now to FIG. 2, with continued reference to FIG. 1, a dataflow diagram illustrates elements of the device 102 of FIG. 1 in accordance with various embodiments. As can be appreciated, various embodiments of the device 102 according to the present disclosure may include any number of modules embedded within the device 102 which may be combined and/or further partitioned to similarly implement systems and methods described herein. Furthermore, inputs to the device 102 may be received from other control modules (not shown) associated with the system 100, and/or determined/modeled by other sub-modules (not shown) within the device 102. In various embodiments, the device 102 includes a control module 110 and a sensor module 112.

The sensor module 112 represents the combination of hardware, software, firmware, processing logic and/or other components associated with the device 102 that is configured to sense, detect, and/or measure one or more characteristics of the pool water directed through the device 102. In various embodiments, the sensor module 112 uses sensor assemblies to sense, detect, and/or measure the characteristics of the pool water or properties of the pool water from which the characteristics may be derived such as, but not limited to, free available chlorine (FAC) concentration, pH, and flow rate. The sensor module 112 generates sensor data 113 that includes various data indicating the sensed, detected, and/or measured characteristics of the pool water.

The control module 110 represents the combination of hardware, software, firmware, processing logic and/or other components associated with the device 102 that is configured to analyze the characteristics of the pool water and, based on the analysis, control the chlorine feed system 103 and the pH control feed system 104 to supply chemicals and/or chemical solutions to the pool water. In various embodiments, the control module 110 receives as input feed system data 111 generated by the chlorine feed system 103 and the pH control feed system 104. The feed system data 111 includes various data indicating operating parameters, operational characteristics, and/or performance information of the chlorine feed system 103 and the pH control feed system 104. The control module 110 also receives as input the sensor data 113 generated by the sensor module 112. The control module 110 processes the sensor data 113 and may determine, based on programmed criteria, quantities or volumes of chemical and/or chemical solutions to be supplied to the pool water to obtain desirable water chemistry. The control module 110 generates control data 115 that includes various data indicating the quantities or volumes of chemical and/or chemical solutions to be supplied to the pool water. The control module 110 may transmit the control data 115 to the chlorine feed system 103 and the pH control feed system 104 and thereby control the chlorine feed system 103 and the pH control feed system 104 to supply the quantities or volumes of chemical and/or chemical solutions.

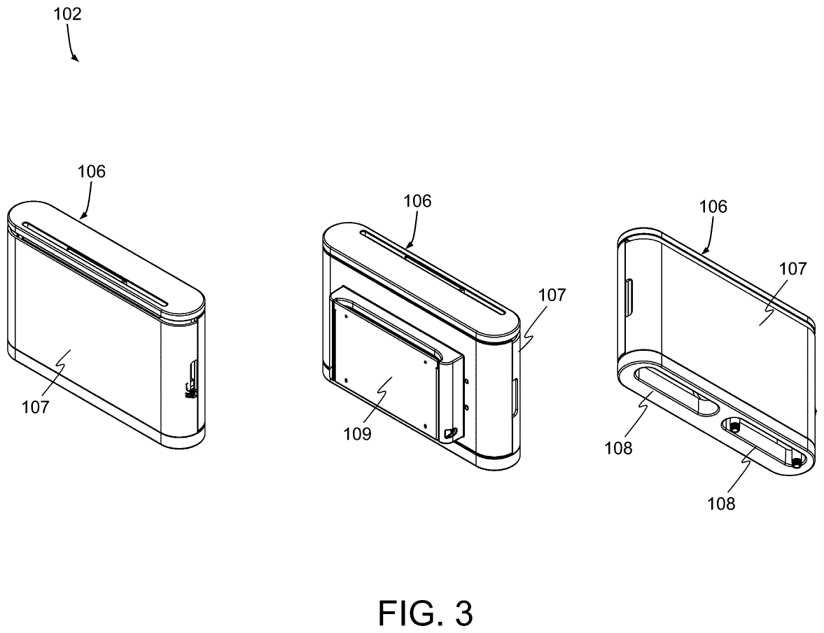

FIGS. 3-12 present various aspects of a nonlimiting embodiment of the device 102. However, it should be understood that the device 102 is not limited to the structure and components represented in FIGS. 3-12.

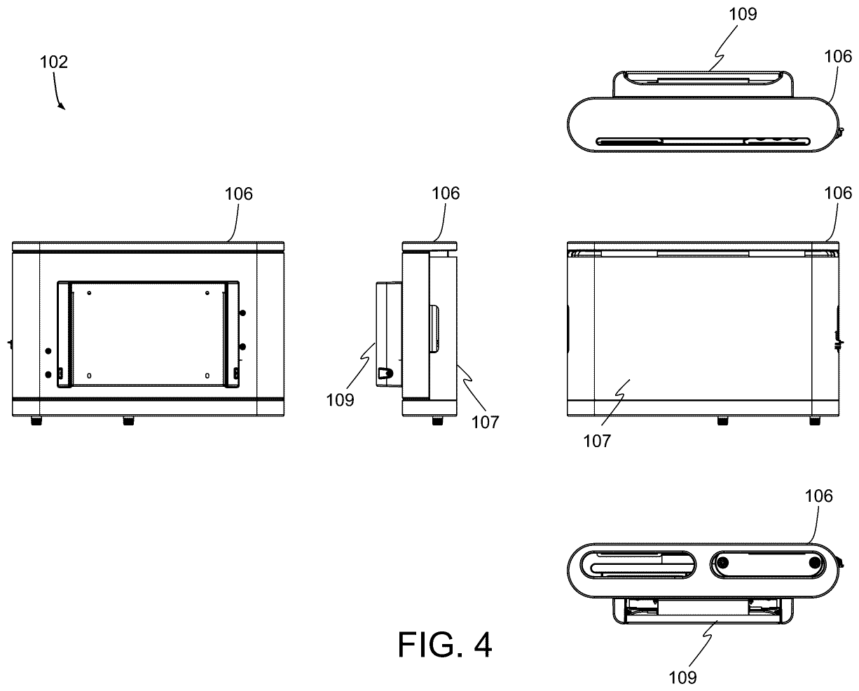

Referring now to FIGS. 3 and 4, in various embodiments the device 102 includes a housing 106 that includes a cover 107 that is removable from a remainder of the housing 106 to provide access to an internal compartment of the housing 106 and a rear compartment 109 configured to store a power supply (not shown) and a mounting plate or other mounting structures. For convenience, the housing 106 is referred to herein as having a top, bottom, front, back, and sides. However, the housing 106 is not limited to any particular shape or size.

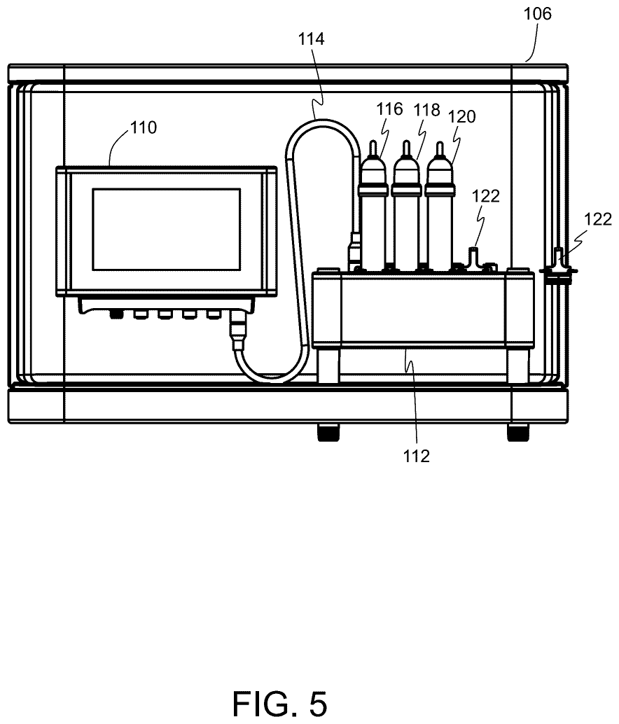

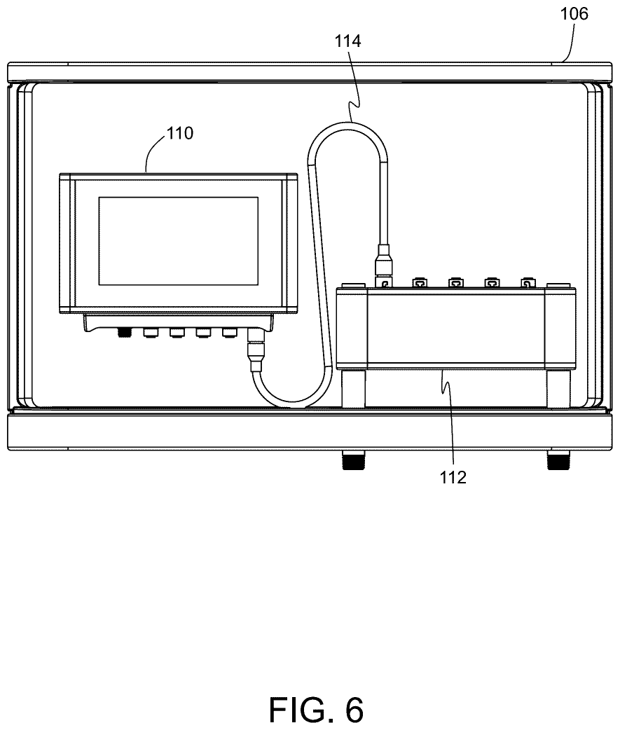

Referring now to FIGS. 5 and 6, the device 102 is presented with the cover 107 removed showing internal components of the device 102, including nonlimiting embodiments of the control module 110 and the sensor module 112 coupled by a data cable 114 for communication therebetween. In FIG. 5, a first pH/ORP sensor assembly 116, a second pH/ORP sensor assembly 118, and a free available chlorine (FAC) sensor assembly 120 are functionally coupled to sensor assembly ports 194 of the sensor module 112. Unoccupied sensor assembly ports 194 may be sealed with port plugs 122. In FIG. 5, the sensor assemblies 116, 118, and 120, and the port plugs 122 are omitted for clarity.

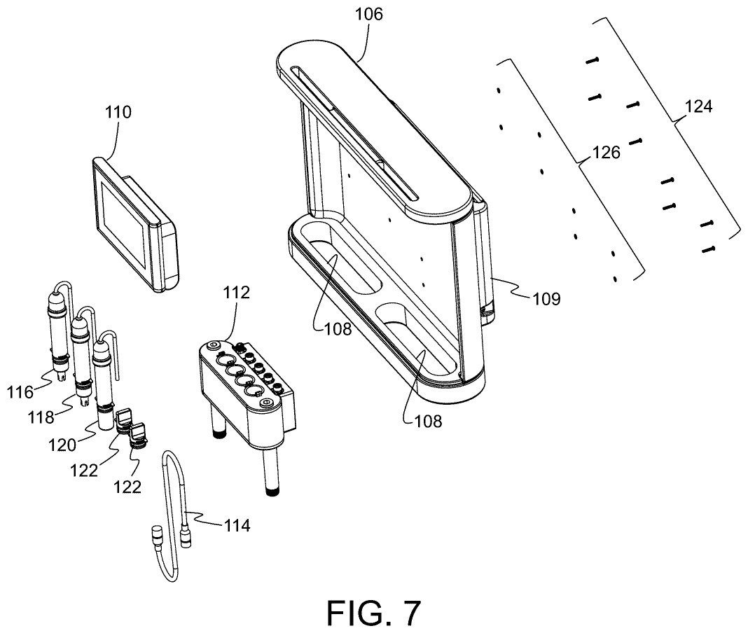

FIG. 7 provides an exploded view of the housing 106 and the internal components thereof. In various embodiments, the control module 110 and the sensor module 112 may be secured within the compartment of the housing 106 with fasteners such as, but not limited to, screws 124 and washers 126. Openings 108 in the bottom of the housing 106 provide access to the compartment for coupling the data cables, power cables, water pipes, etc. from external devices to the control module 110 and/or the sensor module 112.

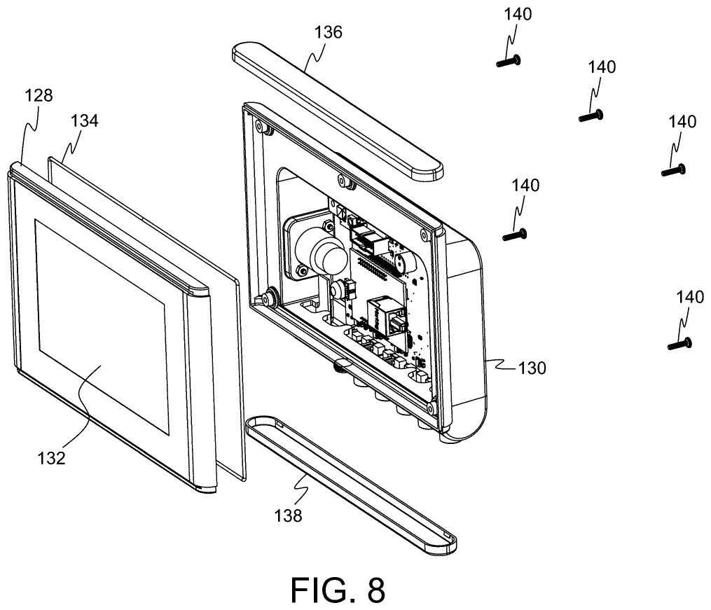

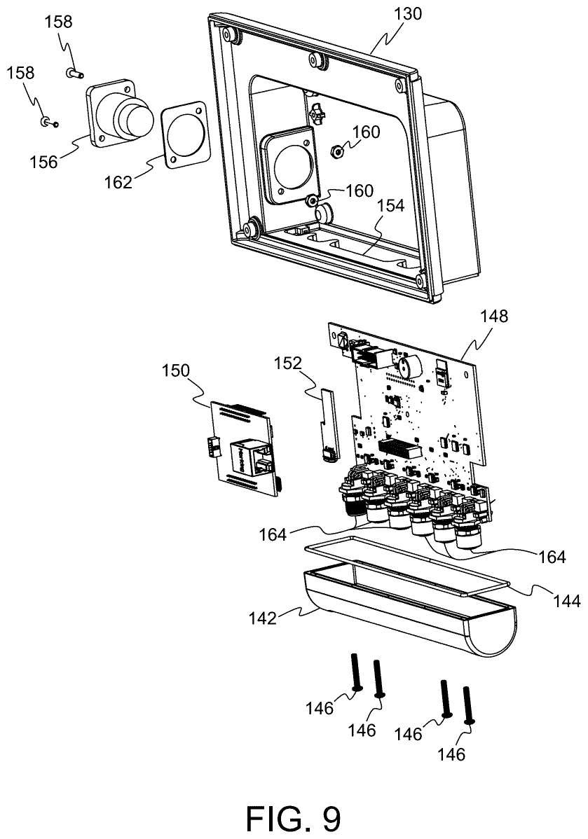

Referring now to FIGS. 8 and 9, exploded views are provided that show exemplary components of the control module 110. In this example, the control module 110 includes a housing that includes a front portion 128 and a back portion 130 that may be coupled to define a compartment therebetween. A sealing member 134 (e.g., O-ring) may be located between the front portion 128 and the back portion 130 to promote a water-tight seal therebetween. The housing may include a top cap 136 and a bottom cap 138. The front portion 128 and the back portion 130 may be coupled with fasteners such as, but not limited to, screws 140.

The compartment of the housing is configured to store electronics and associated components for operation of the control module 110 including, for example, a main printed circuit board (PCB) 148, a processor 150, and a universal serial bus (USB) assembly 152. The main PCB 148 includes various circuitry and components operably coupled by a communication bus that, in combination, are configured to provide communication between the various components of the control module 110 including, but not limited to, the processor 150 and the USB assembly 152. The communication bus may include any suitable physical or logical means of connecting computer systems and components. This includes, but is not limited to, direct hard-wired connections, fiber optics, infrared, and wireless bus technologies.

The main PCB 148 includes control module data ports 164 configured to couple with data cables (e.g., the data cable 114) for communication with other electronic devices such as the sensor module 112. An opening 154 in a bottom of the back portion 130 provides access to the control module data ports 164. In this example, the control module data ports 164 extend through the opening 154 and may be partially covered with an I/O cap 142 configured to releasably couple with a bottom of the housing of the back portion 130. A sealing member 144 (e.g., O-ring) may be located between the I/O cap 142 and the bottom of the housing of the back portion 130 to promote a water-tight seal therebetween. The I/O cap 142 may be coupled to the housing with fasteners such as, but not limited to, screws 146. The control module 110 may include various other ports including, for example, an ethernet port 156 coupled to the housing of the back portion 130 with fasteners, for example, screws 158, nuts 160, and a gasket 162.

The processor 150 may be any custom made or commercially available processor, a central processing unit (CPU), a graphics processing unit (GPU), an auxiliary processor among several processors associated with the control module 110, a semiconductor-based microprocessor (in the form of a microchip or chip set), any combination thereof, or generally any device for executing instructions.

In some embodiments, the control module 110 may include computer readable storage device or media such as, but not limited to, volatile and nonvolatile storage in read-only memory (ROM) and random-access memory (RAM). The computer-readable storage device or media may be implemented using any of a number of known memory devices such as PROMs (programmable read-only memory), EPROMs (electrically PROM), EEPROMs (electrically erasable PROM), flash memory, or any other electric, magnetic, optical, or combination memory devices capable of storing data, some of which represent executable instructions, used by the control module 110.

The instructions may include one or more separate programs, each of which comprises an ordered listing of executable instructions for implementing logical functions. The instructions, when executed by the processor 150, cause the control module 110 to receive and process signals and/or data and provide a water treatment control service configurable to perform logic, calculations, methods and/or algorithms for adjusting one or more characteristics, parameters or other settings associated with at least one of the chlorine feed system 103 and/or the pH control feed system 104.

The USB assembly 152 includes various circuitry, components, and, optionally, instructions configured to operably couple the main PCB 148 to an external electronic device via a USB cable for communication therebetween. In addition to or as an alternative to USB assembly 152, the control module 110 may include one or more other interface assemblies that include circuitry, components, and, optionally, instructions configured to provide communication between the control module 110 and an external electronic device via another physical or wireless connection.

The front portion 128 of the control module 110 may include a display screen 132 configured to render visual graphics thereon based on instructions and/or data received from the processor 150. The visual graphics may include, but are not limited to, information relating to the characteristics of the pool water, information relating to the operation of the device 102, and/or information relating to the operation of the chlorine feed system 103 and/or the pH control feed system 104. In some embodiments, the display screen 132 and/or the control module 110 may include a human-to-machine interface (HMI) configured to allow a user to interact with and/or provide user input to the control module 110.

In some embodiments, the display screen 132 may be configured to provide an HMI via a touchscreen display thereon. In such embodiments, via various display and graphics systems processes, the control module 110 may command and control the touchscreen display to generate a variety of graphical user interface (GUI) objects or elements, for example, buttons, sliders, and the like, which are used to prompt a user to interact with the HMI to provide user input, and to activate respective functions and provide user feedback, responsive to received user input at the GUI element. In such embodiments, the display screen 132 may include a touch sensor and/or a touch sensing system configured to sense the user input (e.g., contact between the display screen 132 and a user's finger or a stylus).

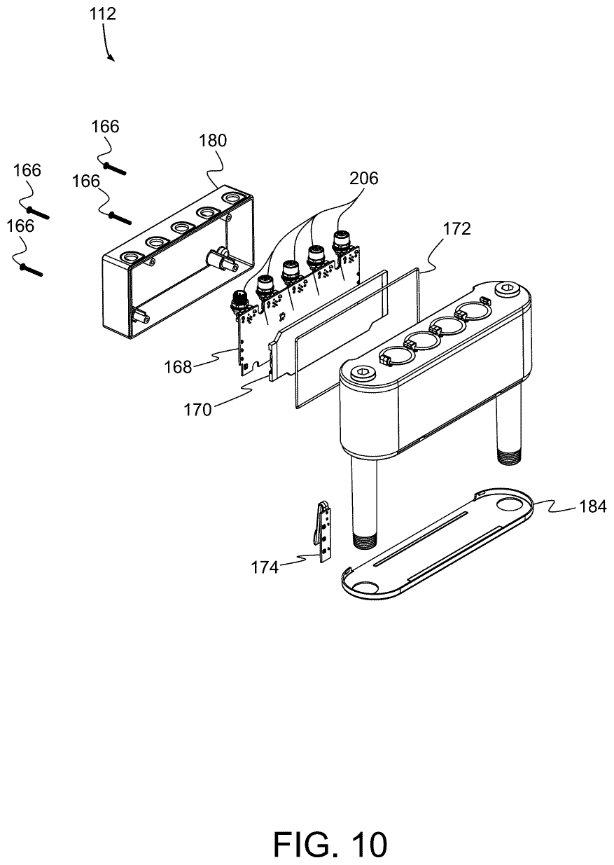

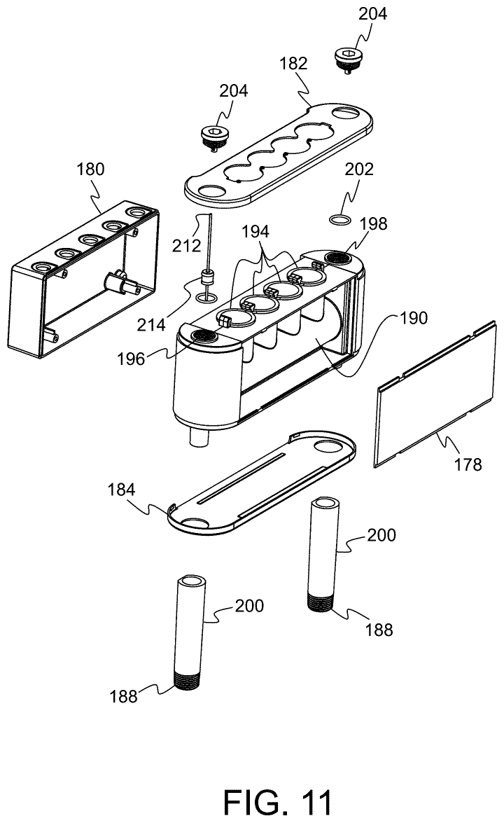

Referring now to FIGS. 10 and 11, exploded views are provided that show nonlimiting components of the sensor module 112. In this example, the sensor module 112 includes a housing that includes a main portion 176, a front portion 178, a back portion 180, a top portion 182, and a bottom portion 184 that may be coupled to define a compartment therebetween. In this example, the front portion 178, the top portion 182, and the bottom portion 184 are coupled to the main portion 176 with snap fit connectors and the back portion 180 is coupled to the main portion 176 with fasteners, such as screws 166. A sealing member 172 (e.g., O-ring) may be located between the main portion 176 and the back portion 180 to promote a water-tight seal therebetween.

Within the compartment, the sensor module 112 includes a manifold having an inlet 186, an outlet 188, and a main pipe 190 providing fluidic communication therebetween. Pipe branches 192 extend from the main pipe 190 and provide fluidic communication therefrom to sensor assembly ports 194 each configured to receive a sensor assembly such that the sensor assemblies are in contact with fluid flowing through the main pipe 190. The inlet 186 and the outlet 188 may be extended with extender posts 200. The sensor module 112 may include an inlet sensor port 196 and an outlet sensor port 198 that are in fluidic communication with the inlet 186 and the outlet 188, respectively. Sealing members 202 (e.g., O-rings) and caps 204 may be used to promote a water-tight seal to the inlet sensor port 196 and the outlet sensor port 198.

Additional components located within the compartment include a sensor module PCB 168, an illuminator 170, and a hall effect sensor assembly 174. The sensor module PCB 168 includes various components and circuitry functionally coupled by a communication bus that are configured to provide communication and operation between the control module 110 and the various components of the sensor module PCB 168. In this example, the sensor module PCB 168 includes five sensor module data ports 206 configured to couple with the control module data ports 164 of the control module 110 via the data cables 114 to provide communication therebetween.

The illuminator 170 is configured to selectively emit light having wavelengths within the visual spectrum. The illuminator 170 may include various types of light emitting elements such as, but not limited to, one or more light emitting diodes. In some embodiments, the illuminator 170 includes a display screen such as a liquid-crystal display (LCD). In such embodiments, the display screen may be integrated or encased within a transparent or semitransparent housing, such as a polycarbonate housing. In some embodiments, the illuminator 170 is configured to selectively emit light at various wavelengths within the visual range of the electromagnetic spectrum, that is, emit various colors of light. In some embodiments, the illuminator 170 is configured to selectively emit a plurality of colors of light in accordance with, for example, the RGB color model.

The hall effect sensor assembly 174 functions in combination with a float pin 212 and a float assembly 214, both located within the inlet sensor port 196, to measure the flow rate of the pool water passing through the manifold. To measure the flow rate, the hall effect sensor assembly 174 detects the position of the float assembly 214 on the float pin 212 which may then be translated into a corresponding flow rate. More specifically, the float assembly 214 is configured to have sufficient buoyancy to float on the pool water passing through the inlet 186. As the flow rate of the pool water increases, the increased volume of the pool water within the manifold causes the float assembly 214 floating thereon to move upwards on the float pin 212. Conversely, as the flow rate of the pool water decreases, the decreased volume of the pool water within the manifold causes the float assembly 214 to move downwards on the float pin 212. The float assembly 214 includes a magnetic material having a magnetic field that is detectable by the hall effect sensor assembly 174. Movement of the float assembly 214 along the float pin 212 produces changes in the strength of the magnetic field detected by the hall effect sensor assembly 174. These change may be measured to determine a precise position of the float assembly 214 which may be converted to a flow rate of the pool water. In some embodiments, the hall effect sensor assembly 174, the float pin 212, and the float assembly 214, in combination, are configured to measure flow rate of the pool water in a range of about 0 to 0.5 gallons per minute (e.g., about 0 to 1.9 liters per minute).

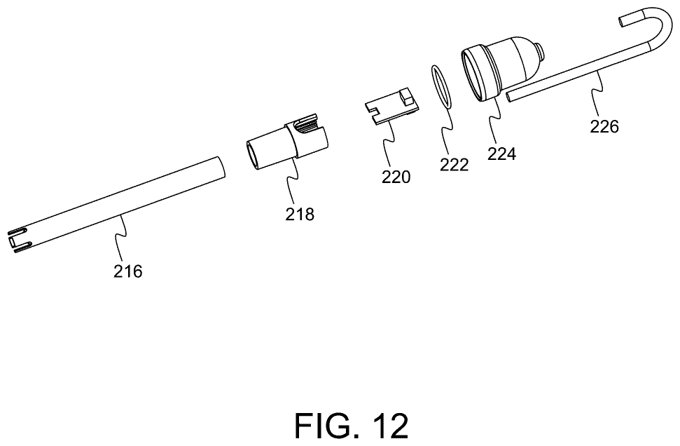

Referring now to FIG. 12, an exploded view is provided that shows nonlimiting components of one of the sensor assemblies. In this example, the sensor assembly includes a probe 216, a PCB cap 218, a sensor PCB 220, a scaling member 222 (e.g., an O-Ring), a tube cap 224, and a sensor cable 226.

A distal end of the probe 216 is configured to contact the pool water and sense a characteristic of the pool water and/or a property of the pool water from which a characteristic of the pool water may be derived. A proximal end of the probe 216 may be secured to a distal end of the PCB cap 218. A distal end of the tube cap 224 is configured to secure to a proximal end of the PCB cap 218 to define a compartment therebetween in which the sensor PCB 220 may be stored. The sealing member 222 may be located between the tube cap 224 and the PCB cap 218 to provide a water-tight seal therebetween. A distal end of the sensor cable 226 may be inserted into an opening in a proximal end of the tube cap 224. The probe 216, the sensor PCB 220, and the sensor cable 226 may be coupled within the compartment and a proximal end of the sensor cable 226 may be coupled to the sensor module PCB 168 to provide communication therebetween. In some embodiments, the sensor cable 226 may be coupled to the sensor module PCB 168 via a M12 connector port.

Notably, the probe 216 and the sensor PCB 220 may be specific to the particular sensor assembly whereas the PCB cap 218, the sealing member 222, the tube cap 224, and the sensor cable 226 may be substantially the same for all of the sensor assemblies. For example, the probes 216 and the sensor PCBs 220 for the first pH/ORP sensor assembly 116 and the second pH/ORP sensor assembly 118 may be configured to sense pH/ORP of the pool water and generate sensor data indicative of the sensed pH/ORP, respectively. In contrast, the probe 216 and the sensor PCB 220 for the FAC sensor assembly 120 may be configured to sense FAC of the pool water and generate sensor data indicative of the sensed FAC.

In some embodiments, the sensor assemblies may each include a unique identifier stored in computer readable memory thereof. The identifier may include various information such as, but not limited to, a type of sensor assembly (e.g., pH sensor, ORP sensor, etc.), a serial number of the sensor assembly, a manufacturing date of the sensor assembly, and/or an installation date of the sensor assembly into the sensor module 112. In such embodiments, the control module 110 may be configured to access and process the identifier of each of the sensor assemblies, identify each of the sensor assemblies by the corresponding identifier thereof, and communicate and/or operate with each of the sensor assemblies based on the identity thereof. For example, different types, brands, etc. of the sensor assemblies may have specific calibrations, programming languages, etc. that may be different from other sensor assemblies. As such, the control module 110 may be configured to properly function with each of the sensor assemblies based on their specific requirements. In addition, the identifier feature provides for the capability for the sensor assemblies to be coupled with any of the sensor assembly ports 194 rather than, for example, requiring dedicated sensor assembly ports 194 for certain types, brands, etc. of the sensor assemblies. Likewise, the identifier feature may provide for communication between any of the sensor module data ports 206 and any of the control module data ports 164 rather than, for example, dedicated sensor module data ports 206 and control module data ports 164 for certain types, brands, etc. of the sensor assemblies.

The sensor assemblies may be calibrated using various processes including, for example, certain wireless devices such as a wirelessly coupled (e.g., Bluetooth™) photometer water testing device (e.g., the WaterLink® Spin Touch® photometer commercially available by the LaMotte Company). In various embodiments, the control module 110 may record an installation date of each of the sensor assemblies and provide life cycle tracking and reporting. In various embodiments, the control module 110 may record and track calibration of the sensor assemblies, track raw, that is, unprocessed or uncalibrated probe measurements as well as calibrated probe values. In such embodiments, the control module 110 may be configured to generate a notification indicating a recommendation for replacement of one or more of the sensor assemblies or the probes 216 thereof. Such recommendations may be based on a predetermined replacement interval or a performance degradation criteria.

In some embodiments, the device 102 may be arranged as a component of a modular system that includes external modules that are in operable communication with the device 102. The external modules are installed in or functionally coupled with other components of the system 100, such as the chlorine feed system 103 and the pH control feed system 104. The external modules may include any combination of hardware, software, firmware, processing logic and/or other components configured to perform their respective intended functions, such as monitoring local operational parameters of the respective components of the system 100, generating and transmitting component data indicative of the monitored local operational parameters to the device 102, and/or providing local actuation of the respective components in response to receiving control commands from the device 102.

In various embodiments, the control module 110 may receive and, optionally, store various component data from the external modules indicative of operational parameters of connected components of the system 100 such as, but not limited to, component status, pump run time and cycle time, solenoid current draw and activation, microcontroller (MCU) temperature, etc. Such component data may be displayed in real-time, for example, on the display screen 132. In some embodiments, the component data may be analyzed for maintenance, optimization, and improvement purposes. In some embodiments, the analysis may be performed using various machine learning techniques.

In some embodiments, the external modules provide local activation to the respective components thereof. For example, an external module associated with the chlorine feed system 103 may provide for activation of chlorine feeder components such as solenoid activation, booster pump activation, and/or dosing pump activation. In such embodiments, the external modules may include various relays, contactors, and/or other electronic parts configured to actuate the respective component in response to receiving an actuation command from the device 102.

In some embodiments, each external module may include a unique identifier stored in computer readable memory thereof. In such embodiments, the control module 110 may be configured to access and process the identifier of each of the external modules, identify each of the external modules by the corresponding identifier thereof, and communicate and/or operate with each of the external based on the identity thereof. In some embodiments, connections between the device 102, the control module 110, and/or the external modules may be agnostic. In some embodiments, the control module 110 may record installation dates of the external modules, provide fault notifications in response to the external modules being disconnected from the device 102 and/or in response to communication errors.

In various embodiments, the device 102 may be configured for wired or wireless communication via a communication network 400 with a remote monitoring system 500 external to the system 100. In various embodiments, the communication network 400 may incorporate various types of systems such as a public or private network implemented in accordance with Transmission Control Protocol/Internet Protocol architectures or other conventional protocol standards. Encryption and mutual authentication techniques may be applied, as appropriate, to ensure data security. In such embodiments, the remote monitoring system 500 may be configured to remotely monitor, analyze, and/or control one or more components of the system 100. For example, the remote monitoring system 500 may receive system data from the device 102 indicative of one or more of dosing amounts of the chlorine feed system 103 and the pH control feed system 104 and/or pool water characteristics, store the system data in a database (locally or in a remote system), and determine and/or display various information based on and/or derived from the system data such as cumulative dosing amounts, performance criteria of the system 100, and/or pool water quality.

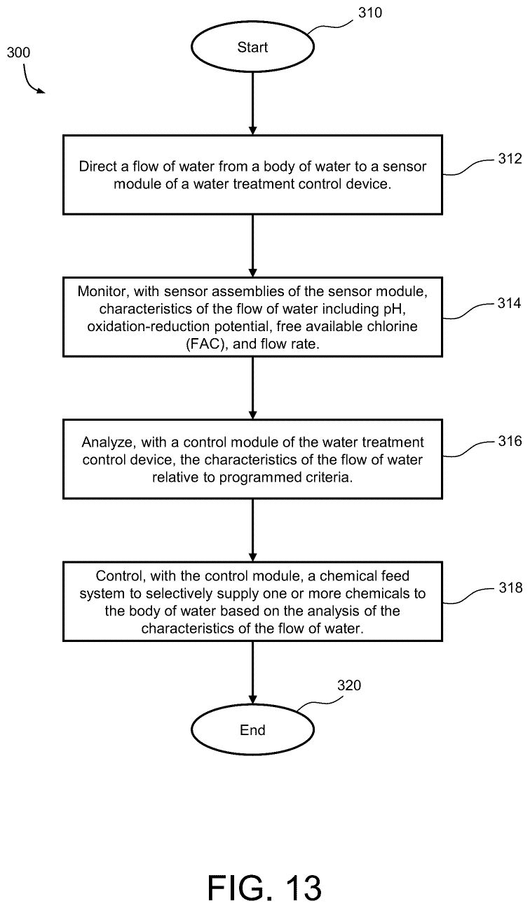

The systems disclosed herein, including the system 100 and the device 102, provide for methods of treating water. For example, FIG. 13 is a flowchart illustrating an exemplary method 300 for treating water. The method 300 may start at 310. In various embodiments, the method 300 may be initiated in response to activation of a water treatment control device (e.g., the device 102), flow of water through the water treatment control device, or another initiating trigger. At 312, the method 300 may include directing a stream of water from a body of water to a sensor module (e.g., the sensor module 112) of the water treatment control device. At 314, the method 300 may include monitoring, with sensor assemblies of the sensor module, characteristics of the stream of water including, for example, pH, oxidation-reduction potential, free available chlorine (FAC), and flow rate. At 316, the method 300 may include analyzing, with a control module of the water treatment control device, the characteristics of the stream of water relative to programmed criteria. At 318, the method 300 may include controlling, with the control module, a chemical feed system to selectively supply one or more chemicals to the body of water based on the analysis of the characteristics of the stream of water. The method 300 may end at 320.

The systems, devices, and methods disclosed herein provide various benefits over certain existing systems, devices, and methods. For example, components of conventional water treatment systems are typically individually operated manually or automatically without communication therebetween. As such, conventional water treatment systems generally require considerable supervision and intervention (i.e., monitoring equipment, periodic water testing, component inspection, etc.) to ensure the components of the water treatment system are functioning as intended and to achieve desirable water chemistry. The systems, devices, and methods disclosed herein provide a single water treatment control device (e.g., device 102) configured to monitor the water chemistry, communicate with other components of the system, such as chemical feed systems, and control such other components to treat the water. Therefore, the systems, devices, and methods disclosed herein effectuate an improvement in the field of water treatment.

Those of skill in the art will appreciate that the various illustrative logical blocks, modules, circuits, and algorithm steps described in connection with the embodiments disclosed herein may be implemented as electronic hardware, computer software, or combinations of both. Some of the embodiments and implementations are described above in terms of functional and/or logical block components (or modules) and various processing steps. However, it should be appreciated that such block components (or modules) may be realized by any number of hardware, software, and/or firmware components configured to perform the specified functions. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention. For example, an embodiment of a system or a component may employ various integrated circuit components, e.g., memory elements, digital signal processing elements, logic elements, look-up tables, or the like, which may carry out a variety of functions under the control of one or more microprocessors or other control devices. In addition, those skilled in the art will appreciate that embodiments described herein are merely exemplary implementations.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration

The steps of a method or algorithm described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC.

Techniques and technologies may be described herein in terms of functional and/or logical block components, and with reference to symbolic representations of operations, processing tasks, and functions that may be performed by various computing components or devices. Such operations, tasks, and functions are sometimes referred to as being computer-executed, computerized, software-implemented, or computer-implemented. In practice, one or more processor devices can carry out the described operations, tasks, and functions by manipulating electrical signals representing data bits at memory locations in the system memory, as well as other processing of signals. The memory locations where data bits are maintained are physical locations that have particular electrical, magnetic, optical, or organic properties corresponding to the data bits. It should be appreciated that the various block components shown in the figures may be realized by any number of hardware, software, and/or firmware components configured to perform the specified functions. For example, an embodiment of a system or a component may employ various integrated circuit components, e.g., memory elements, digital signal processing elements, logic elements, look-up tables, or the like, which may carry out a variety of functions under the control of one or more microprocessors or other control devices.

When implemented in software or firmware, various elements of the systems described herein are essentially the code segments or instructions that perform the various tasks. The program or code segments can be stored in a processor-readable medium or transmitted by a computer data signal embodied in a carrier wave over a transmission medium or communication path. The “computer-readable medium”, “processor-readable medium”, or “machine-readable medium” may include any medium that can store or transfer information. Examples of the processor-readable medium include an electronic circuit, a semiconductor memory device, a ROM, a flash memory, an erasable ROM (EROM), a floppy diskette, a CD-ROM, an optical disk, a hard disk, a fiber optic medium, a radio frequency (RF) link, or the like. The computer data signal may include any signal that can propagate over a transmission medium such as electronic network channels, optical fibers, air, electromagnetic paths, or RF links. The code segments may be downloaded via computer networks such as the Internet, an intranet, a LAN, or the like.

Some of the functional units described in this specification have been referred to as “modules” in order to more particularly emphasize their implementation independence. For example, functionality referred to herein as a module may be implemented wholly, or partially, as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices, or the like. Modules may also be implemented in software for execution by various types of processors. An identified module of executable code may, for instance, comprise one or more physical or logical modules of computer instructions that may, for instance, be organized as an object, procedure, or function. Nevertheless, the executables of an identified module need not be physically located together, but may comprise disparate instructions stored in different locations that, when joined logically together, comprise the module and achieve the stated purpose for the module. Indeed, a module of executable code may be a single instruction, or many instructions, and may even be distributed over several different code segments, among different programs, and across several memory devices. Similarly, operational data may be embodied in any suitable form and organized within any suitable type of data structure. The operational data may be collected as a single data set, or may be distributed over different locations including over different storage devices, and may exist, at least partially, merely as electronic signals on a system or network.

In this document, relational terms such as first and second, and the like may be used solely to distinguish one entity or action from another entity or action without necessarily requiring or implying any actual such relationship or order between such entities or actions. Numerical ordinals such as “first,” “second,” “third,” etc. simply denote different singles of a plurality and do not imply any order or sequence unless specifically defined by the claim language. The sequence of the text in any of the claims does not imply that process steps must be performed in a temporal or logical order according to such sequence unless it is specifically defined by the language of the claim. The process steps may be interchanged in any order without departing from the scope of the invention as long as such an interchange does not contradict the claim language and is not logically nonsensical.

Furthermore, depending on the context, words such as “connect” or “coupled to” used in describing a relationship between different elements do not imply that a direct physical connection must be made between these elements. For example, two elements may be connected to each other physically, electronically, logically, or in any other manner, through one or more additional elements.

As used herein, the term “substantially” denotes within 5% to account for manufacturing tolerances. Also, as used herein, the term “about” denotes within 5% to account for manufacturing tolerances.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention. It being understood that various changes may be made in the function and arrangement of elements described in an exemplary embodiment without departing from the scope of the invention. Finally, while the appended claims recite certain aspects believed to be associated with the invention, they do not necessarily serve as limitations to the scope of the invention.

1. A device, comprising:
a sensor module configured to receive a stream of water from a body of water, the sensor module including sensor assemblies configured to monitor characteristics of the stream of water; and
a control module in operable communication with the sensor module and a chemical feed system configured to supply one or more chemicals to the body of water, the control module configured to, by one or more processors:
receive sensor data from the sensor module indicative of the characteristics of the stream of water;
analyze the characteristics of the stream of water relative to programmed criteria; and
adjust a supply rate of the chemical feed system to supply the one or more chemicals to the body of water based on the analysis of the characteristics of the stream of water.

2. The device of claim 1, wherein the one or more chemicals supplied to the body of water by the chemical feed system include chemicals that affect a chlorine concentration and a pH of the body of water.

3. The device of claim 1, further comprising a display screen configured to render visual graphics thereon indicative of information relating to the characteristics of the stream of water, information relating to the operation of the device, and/or information relating to the operation of the chemical feed system.

4. The device of claim 1, further comprising an illuminator configured to emit light in colors or patterns that indicate a status of the sensor module, a status of the chemical feed system, and/or the characteristics of the stream of water.

5. The device of claim 1, wherein each of the sensor assemblies includes an identifier stored in computer readable memory thereof, wherein the control module is configured to, by the one or more processors:
identify each of the sensor assemblies by the corresponding identifier thereof; and
communicate with each of the sensor assemblies based on the identity thereof.

6. The device of claim 1, wherein the sensor module includes a flow meter configured to sense a flow rate of the stream of water or a condition from which the flow rate may be derived.

7. The device of claim 1, wherein the control module is configured to, by the one or more processors:
receive component data indicative of one or more operational parameters of the chemical feed system; and
transmit the component data to a remote monitoring system.

8. A system comprising:
a chemical feed system configured to supply one or more chemicals to a body of water; and
a water treatment control device that includes:
a sensor module configured to receive a stream of water from the body of water, the sensor module including sensor assemblies configured to monitor characteristics of the stream of water; and
a control module in operable communication with the sensor module and the chemical feed system, the control module configured to, by one or more processors:
receive sensor data from the sensor module indicative of the characteristics of the stream of water;
analyze the characteristics of the stream of water relative to programmed criteria; and
adjust a supply rate of the chemical feed system to supply the one or more chemicals to the body of water based on the analysis of the characteristics of the stream of water.

9. The system of claim 8, wherein the body of water is a commercial or residential pool and the one or more chemicals supplied to the body of water by the chemical feed system include chemicals that affect a chlorine concentration and a pH of the body of water.

10. The system of claim 8, further comprising an external module functionally coupled with the chemical feed system, wherein the external module is configured to activate a function of the chemical feed system in response to receiving a control command from the control module of the water treatment control device.

11. The system of claim 10, further comprising a remote monitoring system configured for receiving system data indicative of information relating to the characteristics of the stream of water generated by the sensor module, information relating to the operation of the water treatment control device generated by the control module, and/or information relating to the operation of the chemical feed system generated by the external module.

12. The system of claim 11, wherein the remote monitoring system is configured to analyze the system data to determine accumulative dosing amounts of the one or more chemicals supplied to the body of water by the chemical feed system.

13. A method, comprising:
directing a stream of water from a body of water to a sensor module of a water treatment control device;
monitoring, with sensor assemblies of the sensor module, characteristics of the stream of water;
analyzing, with one or more processors of a control module of the water treatment control device, the characteristics of the stream of water relative to programmed criteria; and
adjusting, with the one or more processors of the control module, a supply rate of a chemical feed system to selectively supply one or more chemicals to the body of water based on the analysis of the characteristics of the stream of water.

14. The method of claim 13, wherein the one or more chemicals supplied to the body of water by the chemical feed system include chemicals that affect a chlorine concentration and a pH of the body of water.

15. The method of claim 13, further comprising rendering, with the one or more processors of the control module, visual graphics on a display screen of the water treatment control device that are indicative of information relating to the characteristics of the stream of water, information relating to the operation of the water treatment control device, and/or information relating to the operation of the chemical feed system.

16. The method of claim 13, further comprising emitting, with an illuminator of the water treatment control device, lights in colors or patterns indicative of a status of the sensor module, a status of the chemical feed system, and/or the characteristics of the stream of water.

17. The method of claim 13, further comprising, with the one or more processors of the control module:
identify each of the sensor assemblies by a corresponding identifier stored in computer readable memory thereof; and
communicate with each of the sensor assemblies based on the identity thereof.

18. The method of claim 13, further comprising determining a flow rate of the stream of water based on data generated by at least one of the sensor assemblies.

19. The method of claim 13, further comprising:
receiving, by the control module, component data indicative of one or more operational parameters of the chemical feed system; and
transmitting, by the one or more processors, the component data to a remote monitoring system.

20. The method of claim 19, further comprising analyzing, by one or more processors of the remote monitoring system, the component data to determine accumulative dosing amounts of the one or more chemicals supplied to the body of water by the chemical feed system.
